(19) United States
(12) Patent Application Publication
(10) Pub. No.: US 2009/0284646 A1
(43) Pub. Date: Nov. 19, 2009

(54) FLASH MODULE AND IMAGE CAPTURING DEVICE HAVING SAME

(75) Inventors: TA-HSAING CHAO, Tu-Cheng (TW); KUAN-TE HUANG, Tu-Cheng (TW); SHANG-YI LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/189,105

(22) Filed: Aug. 8, 2008

(30) Foreign Application Priority Data
May 16, 2008 (CN) 200810301605.9

(51) Int. Cl. H04N 5/222

(52) U.S. Cl. 348/371; 348/E05.022

(57) ABSTRACT

An image capturing device includes a main body and a flash module disposed on a surface of the main body. The flash module includes a lamp tube, a reflector, and a rotating shaft. The reflector is configured for reflecting the light emitted from the lamp tube. The rotating shaft is assembled on the main body and rotatable relative to the main body. The rotating shaft is secured on a surface of the reflector facing away from, and parallel to the lamp tube.

### TECHNICAL FIELD

The present invention relates to flash modules, and particularly to a built-in flash module capable of changing flash direction and an image capturing device having the same.

### DESCRIPTION OF THE RELATED ART

Flash modules have been widely used now in the field of photography for improving brightness of objects to be captured. A built-in flash module of a typical image capturing device usually has a fixed flash direction the same as the viewing direction of the lens module of the image capturing device. As a result, the built-in flash module can only directly irradiate an object to be captured, which usually causes the object to be too sharp and casts a shadow at the side thereof.

In order to overcome the problem, a flash module disposed outside of the image capturing device is used for improving brightness of objects. The flash module is linked to the image capturing device and can rotate relative to the image capturing device to change its flash direction, therefore, can overcome the problem. However, the flash module disposed outside of the image capturing device makes the image capturing device bulky and limits possible designs for miniaturization.

What is needed, therefore, is a built-in flash module and an image capturing device having the same to overcome the above-described problem.

### SUMMARY

In an exemplary embodiment, an image capturing device includes a main body and a flash module disposed on a surface of the main body. The flash module includes a lamp tube, a reflector, and a rotating shaft. The reflector is configured for reflecting the light emitted from the lamp tube. The rotating shaft is assembled on the main body and rotatable relative to the main body. The rotating shaft is secured on a surface of the reflector facing away from, and parallel to, the lamp tube.

### BRIEF DESCRIPTION OF THE DRAWINGS

Many aspects of the present flash module and related image capturing device can be better understood with reference to the accompanying drawings. The components in the drawing are not necessarily drawn to scale, the emphasis instead being placed upon clearly illustrating the principles of the present flash module and related image capturing device.

FIG. 1 is a schematic, isometric view of an image capturing device according to a first exemplary embodiment.

FIG. 2 is a schematic, isometric view of an image capturing device according to a second exemplary embodiment.

FIG. 3 is a schematic, isometric view of an image capturing device according to a third exemplary embodiment.

### DETAILED DESCRIPTION OF THE EMBODIMENTS

Embodiments of the present invention will now be described in detail below, with reference to the accompanying drawings.

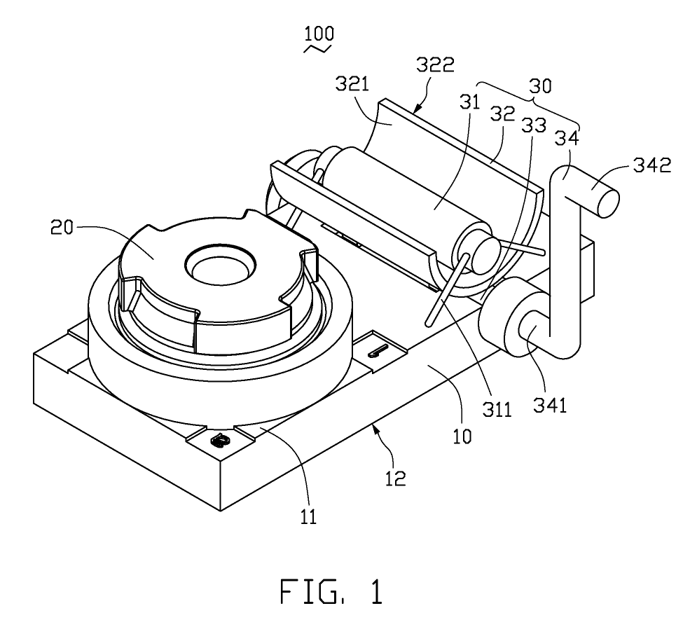

Referring to FIG. 1, an image capturing device 100, according to a first exemplary embodiment, is shown. The image capturing device 100 includes a main body 10, a lens module 20, a flash module 30, and a casing (not shown) for housing the main body 10, the lens module 20, and the flash module 30.

The main body 10 includes a first surface 11 and an opposite second surface 12. Both of the lens module 20 and the flash module 30 are disposed on the first surface 11.

The flash module 30 includes a lamp tube 31, a reflector 32 for reflecting the light emitted from the lamp tube 31, and a rotating shaft 33.

The lamp tube 31 is received in the reflector 32. In the present embodiment, the lamp tube 31 is secured to the main body 10 with a number of supporting rods 311. Two ends of the lamp tube 31 are connected with the supporting rods 311 extending from the main body 10.

The shape of the reflector 32 is a portion of cylinder or a portion of elliptic cylinder with an axis thereof parallel to the lamp tube 31. In case that the shape of the reflector 32 is a portion of elliptic cylinder, and the lamp tube 31 is arranged along the foci line of the elliptic cylinder. The reflector 32 can be made of reflective material entirely. However, in order to cut down the cost of the reflector 32, the reflector 32 can be made of a relative cheap material with a first surface 321 facing to the lamp tube 31 covered with a reflective coating. A second surface 322 of the reflector 32 facing away from the lamp tube 31 is secured on the rotating shaft 33. So that the reflector 32 can rotate together with the rotating shaft 33.

The rotating shaft 33 is assembled on the main body 10, and is rotatable relative to the main body 10. In the present embodiment, the rotating shaft 33 is disposed parallel to the lamp tube 31 to reduce the volume of the flash module 30, accordingly, benefiting the miniaturization of the image capturing device 100. The rotating shaft 33 can also be integrally formed with the reflector 32 to reduce the difficulty of assembling the flash module 30.

In the present embodiment, the flash module 30 also includes a driving handle 34 for rotating the rotating shaft 33. The driving handle 34 has a first end 341 fixed to an end of the rotating shaft and a second end 342 opposite to the first end 341 extending out of the casing (not shown). Using the handle 34, users can rotate the rotating shaft 33 to change the flash direction of the flash module 30. Furthermore, the driving handle 34 can be integrally formed with the rotating shaft 33 to reduce the difficulty of assembling the flash module 30.

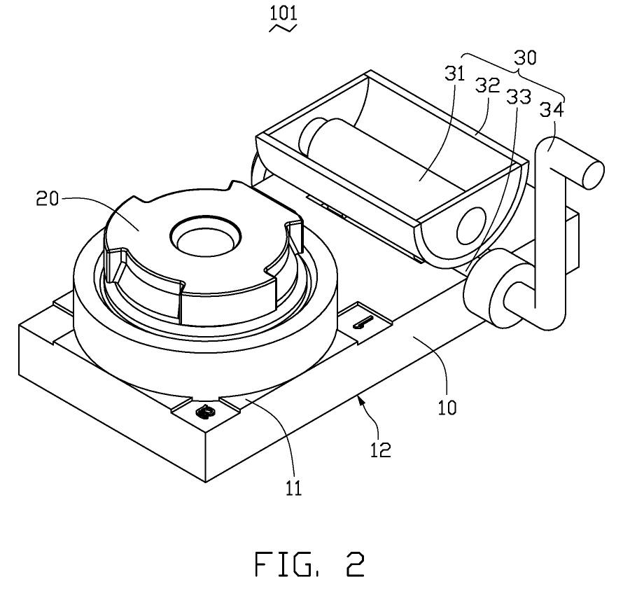

Referring to FIG. 2, an image capturing device 101, according to a second exemplary embodiment, is shown. The image capturing device 101 is similar to the image capturing device 100 of the first exemplary embodiment except for the fixing manner of the lamp tube 31. In this embodiment, the lamp tube 31 is secured to the reflector 32, and while the lamp tube 31 is secured to the main body 10 in the first embodiment.

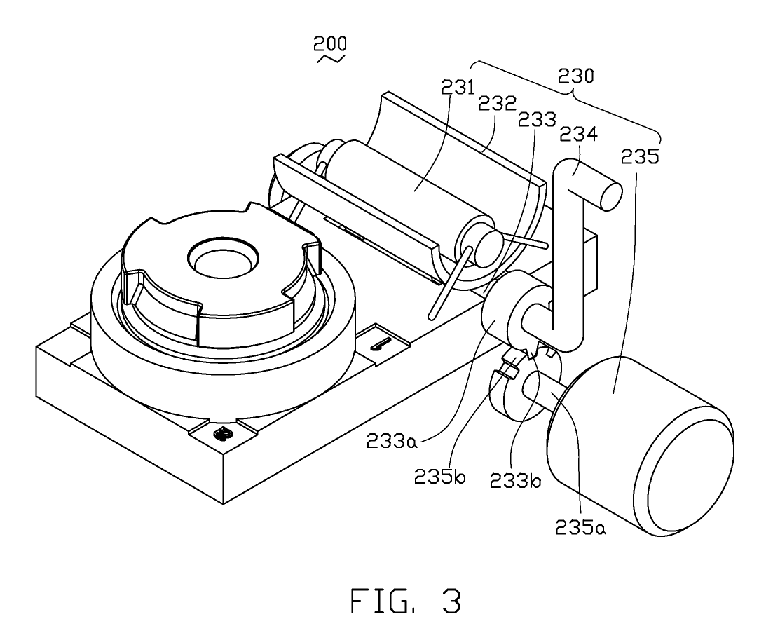

Referring to FIG. 3, an image capturing device 200, according to a third exemplary embodiment, is shown. The image capturing device 200 includes a flash module 230. The flash module 230 includes a lamp tube 231, a reflector 232, a rotating shaft 233, and a driving handle 234. The image capturing device 200 is similar to the image capturing device 100 of the first exemplary embodiment. The difference between them is that the flash module 230 further includes a motor 235 disposed in the image capturing device 200 for driving the rotating shaft 233. In the present exemplary embodiment, the rotating shaft 233 also has a annular projection 233a with teeth 233b extending outward from the peripheral surface of the projection 233a, and the motor 235 has a shaft 235a with teeth 235b capable of engaging with the teeth 233b. By the above-described structure, in the image capturing device 200 of the third exemplary embodiment, the rotating shaft 233 can be rotated not only automatically by the motor 235, but also manually by the driving handle 234.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. An image capturing device comprising:
a main body; and
a flash module disposed on a surface of the main body, the flash module comprising
a lamp tube;
a reflector for reflecting the light emitted from the lamp tube; and
a rotating shaft assembled on the main body and rotatable relative to the main body, the rotating shaft secured on a surface of the reflector facing away from, and parallel to the lamp tube.

2. The image capturing device as claimed in claim 1, wherein the flash module further comprises a driving handle with one end fixed to the rotating shaft for rotating the rotating shaft.

3. The image capturing device as claimed in claim 1, wherein the flash module further comprises a motor connected with the rotating shaft for rotating the rotating shaft.

4. The image capturing device as claimed in claim 1, wherein the rotating shaft is integrally formed with the reflector.

5. The image capturing device as claimed in claim 1, wherein the lamp tube is secured to the reflector.

6. The image capturing device as claimed in claim 1, wherein the lamp tube is secured to the main body.

7. The image capturing device as claimed in claim 1, wherein the reflector is made of reflective material entirely.

8. The image capturing device as claimed in claim 1, wherein a surface of the reflector facing to the lamp tube is covered with a reflective coating.

9. The image capturing device as claimed in claim 1, wherein the shape of the reflector is a portion of cylinder or a portion of elliptic cylinder with an axis parallel to the lamp tube.

10. The image capturing device as claimed in claim 1, wherein the shape of the reflector is a portion of elliptic cylinder and the lamp tube is arranged along the foci line of the elliptic cylinder.

11. A flash module, comprising:
a lamp tube;
a reflector for reflecting the light emitted from the lamp tube; and
a rotating shaft secured on a surface of the reflector facing away from the lamp tube and parallel to the lamp tube.

12. The flash module as claimed in claim 11, wherein the flash module further includes a driving handle with one end fixed to the rotating shaft for rotating the rotating shaft.

13. The flash module as claimed in claim 11, wherein the flash module further comprise a motor connected with the rotating shaft for rotating the rotating shaft.

14. The flash module as claimed in claim 11, wherein the rotating shaft is integrally formed with the reflector.

15. The flash module as claimed in claim 11, wherein the reflector is made of reflective material entirely.

16. The flash module as claimed in claim 11, wherein a surface of the reflector facing to the lamp tube is covered with a reflective coating.

17. The flash module as claimed in claim 11, wherein the shape of the reflector is a portion of cylinder or a portion of elliptic cylinder with an axis parallel to the lamp tube.

18. The flash module as claimed in claim 11, wherein the shape of the reflector is a portion of elliptic cylinder and the lamp tube is arranged along the foci line of the elliptic cylinder.
